(19) United States
(12) Patent Application Publication
(10) Pub. No.: US 2021/0025276 A1
(43) Pub. Date: Jan. 28, 2021

(54) Process for Sealing Joints Between Prefabricated Ashlars or Similar Construction Elements, in Particular in The Construction of Tunnels and Galleries, and Corresponding Sealing System and Strip

(71) Applicant: MAPEI S.p.A., Milano (IT)

(72) Inventors: Enrico Dal Negro, Milano (IT); Davide Michelis, Milano (IT); Alessandro Boscaro, Milano (IT); Alessio Chieregato, Milano (IT)

(73) Assignee: MAPEI S.p.A., Milano (IT)

(21) Appl. No.: 16/935,738

(22) Filed: Jul. 22, 2020

(30) Foreign Application Priority Data
Jul. 22, 2019 (IT) 102019000012477

(51) Int. Cl. E21D 11/38; B29C 65/70; B29C 65/00; E21D 11/08

(52) U.S. Cl. CPC E21D 11/385; E21D 11/083; B29C 66/30321; B29C 65/70

(57) ABSTRACT

A process (10) for the sealing of joints (G) between prefabricated ashlars (C) or similar construction elements, comprising the following steps:
inserting of a sealing strip (11), of plastic material, in a joint (G) between two adjacent prefabricated ashlars (C) so that the sealing strip (11), once inserted, extends along the joint (G) to be sealed; and
injecting, by means of an injector tool (A), of a sealing resin (12) into the interior of the joint (G), so as to distribute, thanks to the containment and confinement action of the sealing strip (11) inserted in the joint (G), the sealing resin (12) along the extension of the joint (G) and therefore fill it;
wherein the sealing strip (11) has, preferably, in section, a special configuration showing a plurality of inclined fins (11c), protruding from a central body (11b), apt to co-operate with the walls of the joint (G) in which the sealing strip (11) is inserted, so as to prevent the escape of the sealing resin (12) and the detachment of the sealing strip (11) from the joint (G) due to the pressure (P) applied by the sealing resin (12) which is injected into the joint (G).

The process of the invention offers safe sealing that can be carried out easily and fast, and therefore advantageously allows a reduction in the construction and maintenance costs of the galleries and tunnels wherein the joints between these prefabricated ashlars must be appropriately sealed so as to avoid infiltration and similar phenomena.

### TECHNICAL FIELD OF THE INVENTION

The present invention relates in general to the construction sector, and more specifically relates to a process and a corresponding system for sealing joints between prefabricated ashlars, or similar construction elements, wherein both the process and the corresponding sealing system appear particularly suitable and advantageous for sealing the joints between prefabricated ashlars which usually constitute the lining walls of galleries and tunnels.

The subject of the present invention also is a special sealing strip, in plastic material, apt to be advantageously inserted in a joint between two adjacent ashlars in order to seal it, in particular in the construction and maintenance of tunnel and gallery lining walls.

### STATE OF THE PRIOR ART

In the sector of gallery and tunnel construction, the tunnels and galleries, after having been excavated in the rock and in the soil by means of the so-called TMB, acronym of Tunnel Boring Machine, are usually lined in their interior with walls and interior cladding made of prefabricated ashlars or similar construction elements, which, when they are installed, form a plurality of joints between them which must be suitably sealed so as to prevent seepages of water and other similar infiltrations from the rock and from the soil, in which the tunnel and the gallery have been excavated, towards the interior of the same tunnel and gallery.

For this purpose, the prefabricated ashlars used to line internally the excavation of these tunnels and galleries are usually fitted with appropriate seals, mounted directly on the ashlars before they are installed, with the purpose specifically of sealing the joints that are formed between the various ashlars when they are installed and placed one to the side of the other to cover the tunnel and the gallery.

Unfortunately, the seals that seal these joints between prefabricated ashlars are subject to degradation and damage over time, for example to misalignment, such as to lose at least part of their capacity for sealing the joint and therefore of preventing the seepages towards the interior of the tunnel and of the gallery, so that the non-negligible problem arises of repairing and restoring the sealing of these joints.

For the sake of completeness, the photographic images of FIGS. 4A and 4B show a plurality of prefabricated ashlars, denoted by (C), apt to be used for lining the excavation of tunnels and galleries, and therefore prepared with appropriate seals having the function of sealing the joints between the various ashlars, when they are installed and therefore placed one to the side of the other, in order to prevent infiltration and similar phenomena towards the interior of the tunnel and of the gallery.

In this context, the state of the art proposes different methods and solutions for sealing these joints between adjacent ashlars.

Among these known techniques for sealing joints between ashlars and prefabricated concrete elements, particularly in the construction and maintenance of galleries and tunnels, the following are mentioned.
Rope method: this is a method, currently decidedly obsolete and in disuse, in which a cotton rope/cable is used which is soaked on site with a single-component polyurethane resin and then, manually, inserted in the joint. The PU (polyurethane) of the resin then reacts with the water to harden and seal the joint.
Mortar method: in this case all the joints are grouted with a medium/fast-setting mortar for a section of the tunnel. There is then a waiting time until the mortar has matured and hardened sufficiently and then the mortar is drilled in some points to allow the installation of the injection packer, i.e. the injection tool, through which the resin for sealing the joint is injected and conveyed.

The current techniques, both the simpler and more generic ones and the more specific and complex ones, are in any case not without limits and disadvantages, so as to leave room for further improvements.

In particular, the need is felt, in this field, to further reduce the construction times, and consequently the costs, of the sealing of these joints between prefabricated ashlars, as well as to further improve the solidity and ruggedness over time of the sealed joints, especially where there are particularly critical conditions as to require the sealing to be perfectly and stably anchored to the joint to be sealed and not subject to degradation over time that would compromise the capacity therefore for sealing against infiltrations.

### SUMMARY OF THE INVENTION

Therefore, the primary object of the present invention is to propose a process and a corresponding system for the sealing of joints between prefabricated ashlars, or similar construction elements, in particular in the construction and maintenance of tunnels and galleries, which corresponds to a significant improvement with respect to the processes and systems currently in use in this field.

More particularly, in this context, the object of the present invention is to propose a process and a corresponding system for the sealing of joints between prefabricated ashlars, or similar construction elements, apt to be advantageously applied and used should it be necessary to intervene to repair or replace pre-existing seals of joints between prefabricated ashlars, in particular constituting the lining walls of tunnels and galleries, which have deteriorated and been damaged over time so that these seals have lost their capacity for preventing seepages and infiltrations towards the interior of the tunnel and of the gallery.

A further object of the present invention is also to develop and propose a process for the sealing of joints between prefabricated ashlars that can be carried out in a short space of time, and to this end avoids in particular the perforations that are foreseen by the sealing processes and systems currently in use, such as for example the mortar method illustrated previously.

Yet another object of the present invention is to propose a new sealing strip, configured in order to be inserted in a joint between two ashlars in order to seal it, which has innovative features and improved performances with respect to those currently adopted and in use for this purpose in the prior art.

These objects are achieved by the process and by the corresponding system for the sealing of joints between prefabricated ashlars, having respectively the features disclosed by independent claims 1 and 7, and by the sealing strip exhibiting the features disclosed by independent claim 9.

Particular embodiments of this new process and new system, and of this new sealing strip, are also defined by the independent claims.

### Advantages of the Invention

As will be made clear by the rest of the description, the process, in accordance with the present invention, for the sealing of joints between prefabricated ashlars, and the corresponding system offer a series of significant advantages, some of which already illustrated previously, including the following mentioned purely by way of example:
considerable simplification of the process of sealing of the joints between the prefabricated ashlars, it not being necessary, as in the conventional art, to drill the ashlars and use standard packers, that is sealing tools;
easy and uncomplicated insertion of the sealing strip in the joint;
adaptability of the sealing strip, an essential part of the process of the invention, to the shape of the joint to be sealed, so as to ensure a perfect tightness of the joint and at the same time contrast the pressure, applied on the sealing strip, tending to detach it from the joint in which it is inserted;
effective alternative to conventional systems and processes in those cases in which these are in fact inapplicable or have significant disadvantages.

### BRIEF DESCRIPTION OF THE DRAWINGS

These and other objects, features and advantages of the present invention will be made clear and evident by the following description of one of its preferred embodiments, given purely by way of a non-limiting example with reference to the accompanying drawings, in which:

FIG. 1, divided into sections (a)-(l), is a series of photographic images that show in detail the various phases, as provided by the process and system of sealing of the invention, for sealing a joint between prefabricated ashlars, in particular in the construction and maintenance of a gallery;

FIG. 2A is a photographic image of a sealing strip, of plastic material, used in the process and in the system of the invention illustrated in FIG. 1, and an essential part of the same;

FIG. 2B is a diagram that shows in section a joint, between two adjacent ashlars, sealed by means of the process and system of sealing of the invention of FIG. 1;

FIG. 3 is a block working diagram corresponding to the process and system of sealing of the invention of FIG. 1; and

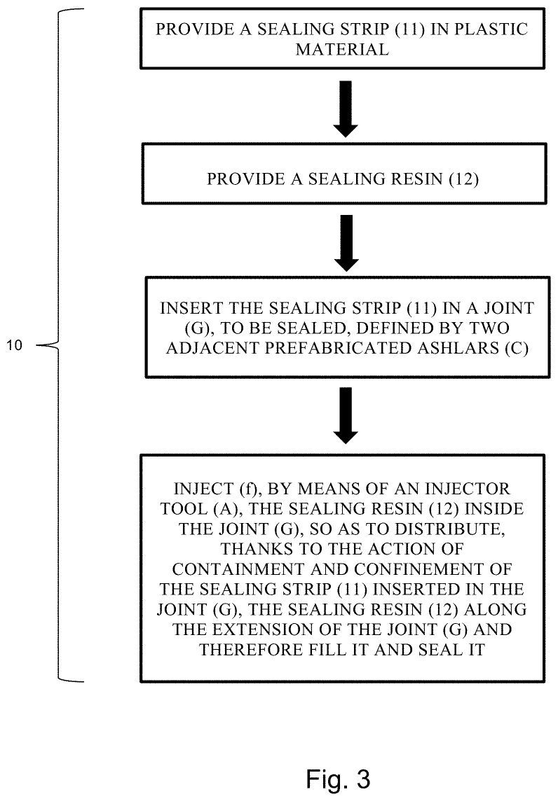

FIGS. 4A and 4B are photographic images that show a plurality of ashlars which can be used in accordance with the prior art in the construction of galleries and tunnels, prepared with seals having the function of sealing the joints between these ashlars, during their installation.

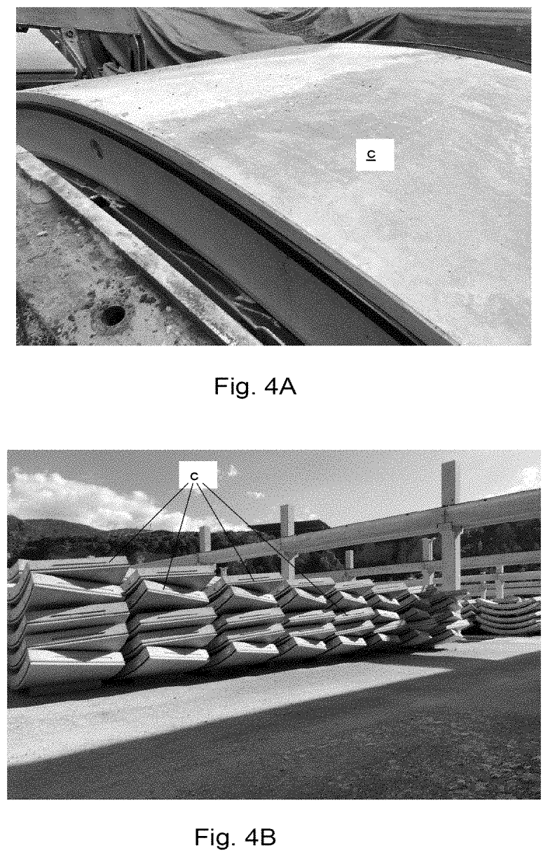

### DESCRIPTION OF A PREFERRED EMBODIMENT OF THE INVENTION

Referring to the drawings, a process, in accordance with the present invention, for the sealing of joints between prefabricated ashlars or similar construction elements, is denoted overall by (10).

As mentioned above, the sealing process (10) of the invention is particularly suitable and advantageous for effectively sealing a joint defined by two ashlars, which are mounted and placed adjacent one to the other, for example in the construction of walls and linings of galleries and tunnels.

In detail, the sealing process (10) comprises the following steps:
inserting of a sealing strip (11), of plastic material, into a joint (G), to be sealed, defined by two prefabricated, adjacent ashlars (C);
injecting, by means of a special injector tool (A), of a sealing resin (12), in the interior of the joint (G) to be sealed, so as to distribute, thanks to the containment and confinement action of the sealing strip (11) inserted in the same joint (G), the sealing resin (12) along the extension of the joint (G) and therefore fill it.

Preferably, but not exclusively, the sealing resin (12), used in the sealing process (10) of the invention, is injected inside the joint (G), by means of the injector tool (A), in a lateral zone or point (Z) adjacent to one end of the sealing strip (11), once it has been inserted in the joint (G) to be sealed.

It is clear, however, that the sealing resin (12) can be injected inside the joint (G), by means of the injector tool (A), also in other points and in other ways inside the joint (G), in order to fill it.

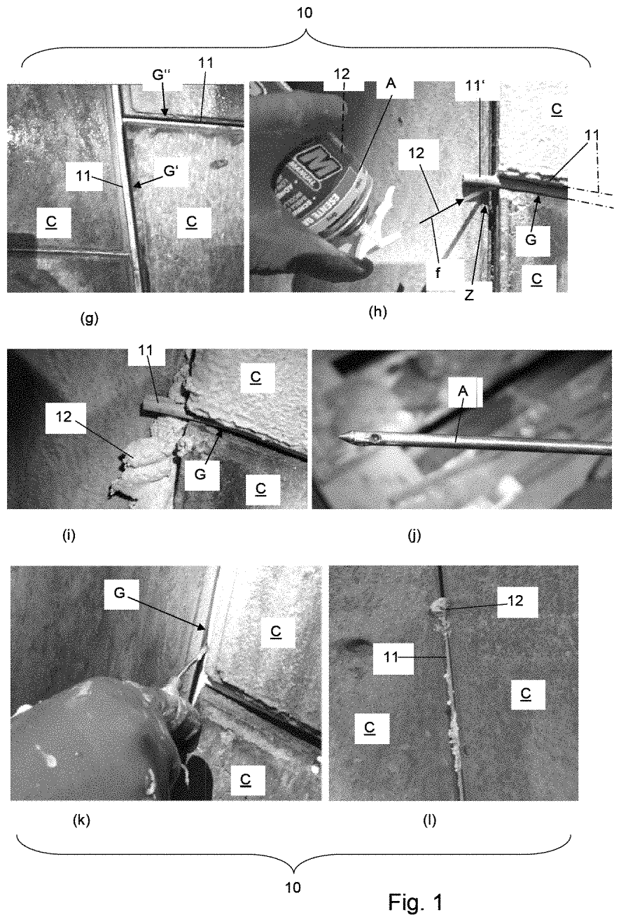

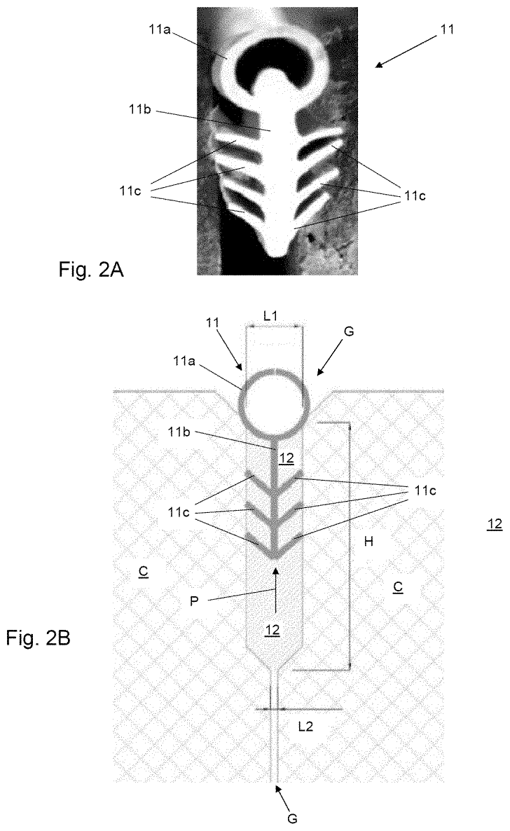

Moreover, still preferably but not exclusively, the sealing strip (11), in plastic material, used and an essential part of this sealing process (10) of the invention, presents in section a special configuration or profile, as shown in FIGS. 2A and 2B, exhibiting:
a main body, denoted by (11a), more particularly hollow, formed at one end of the sealing strip (11);
a central body, denoted by (11b), exhibiting an elongated shape, which extends from the main body (11a); and
a plurality of fins or tabs, denoted by (11c), protruding from the central body (11b), elongated in shape,

wherein the main body (11a), the central body (11b) and the protruding fins (11c) are made with the plastic material in a single piece.

Thanks to this special configuration in section of the sealing strip (11), the respective main body (11a) is apt to extend in length along the edge of the joint (G) which faces the outside and the central body (11b) to extend from the main body (11a) towards the interior of the same joint (G) when the sealing strip (11) is inserted in the joint (G) in order to seal it.

In addition, the fins (11c) have an inclination, with respect to the central body (11b) from which they protrude, such that, when the sealing strip (11) is subjected to a pressure P, as schematised in FIG. 2B, tending to detach it from the joint (G) in which the same sealing strip (11) is inserted, such as the pressure that is exerted by the sealing resin (12) when it is injected into the joint (G), the fins (11a) co-operate effectively with the walls of the joint (G) so as to prevent the detachment of the sealing strip (11) from the joint (G), as well as the escape of the sealing resin (12) that is injected.

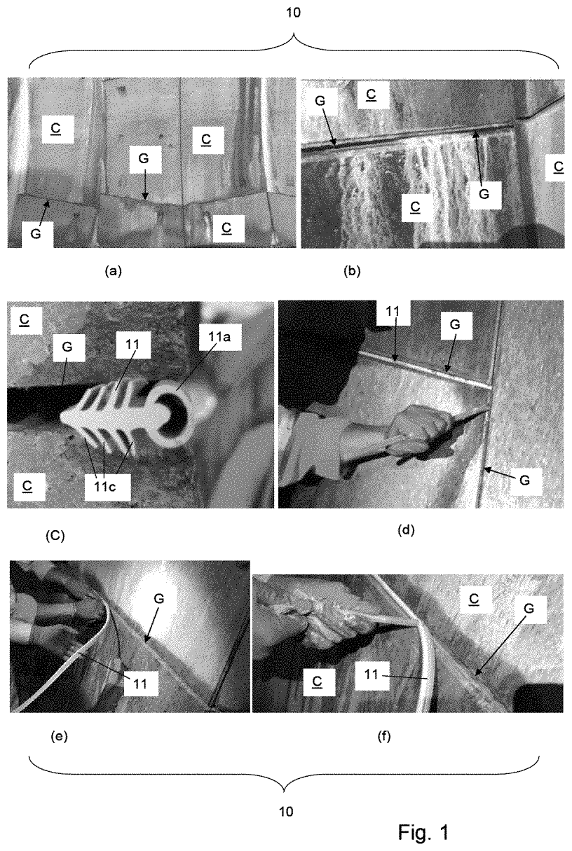

For the sake of clarity and to provide more complete information, the photographic images in FIG. 1—sect. (a)-(l) show in detail the various steps, as provided by the sealing process (10) of the invention and illustrated in the following table, for sealing a joint (G), between two prefabricated ashlars (C).

| Section | |
|---|---|
| FIG. 1 | Description of the photographic image |
| (a) | Area, with the presence of joints between prefabricated |
| | ashlars, involved in the sealing of the joints by means of the |
| | sealing process (10) of the invention. |
| (b) | Area involved with the presence of concretions and other |
| | infiltrations between the joints. |
| (c) | Picture of the sealing strip (11), to be inserted in a joint |
| | (G), showing a finned profile so as to ensure a perfect tightness |
| | against the pressure exerted by the sealing resin when it is |
| | injected inside the joint. |
| (d) | Cleaning of the joint (G) to be sealed, in particular from |
| | formations of CaCO3 that could be present due to water running |
| | along the joint. |
| (e) | Introduction of the sealing strip (11) inside the joint (G). |
| (f) | Use of a tool for pushing and inserting the sealing strip (11) |
| | inside the joint (G). |
| (g) | Picture of the point of joining between the sealing strips |
| | (11) introduced into a vertical joint (G)′ and into horizontal joint |
| | (G)”. |
| (h) | Extrusion and injection, by means of the appropriate |
| | injector tool (A), of the sealing resin (12) in the joint (G), as |
| | indicated by an arrow f, in the point or zone (Z) adjacent to one |
| | end (11)′ of the sealing strip (11) which has been inserted in the |
| | joint (G) to be sealed. |
| (i) | Enlarged image of the point of joining between a horizontal |
| | joint and a vertical joint, after the injection of the sealing resin |
| | (12). |
| (j) | Enlarged image of a needle of the tool A used to inject the |
| | sealing resin (12). |
| (k) | Use of the needle during the injection of the sealing resin |
| | (12). |
| (l) | Detailed image of the joint (G) after the injection of the |
| | sealing resin (12). |

For the sake of completeness, with reference to FIG. 2B, the following are some purely indicative numerical values of the salient dimensions of a typical joint (G) in which the sealing strip (11) is insertable and inserted in order to seal it, and therefore implicitly also in the dimensions of the same sealing strip (11).
H: depth of the joint (G) sealed by the sealing strip (11) and the sealing resin (12)=approx. 40 mm;
L1: width of the joint (G) in the zone, flush with the surface of the two ashlars (C), that faces outwards=approximately 8-9 mm;
L2: width of the joint (G), in the zone towards the interior of the two ashlars (C)=approximately 1 mm.

The sealing resin (12) which is used in the sealing process (10) and which therefore, when it is injected inside the joint (G), is trapped and confined by the sealing strip (11) inserted in the same joint (G), has substantially known features and will therefore only be described briefly.

For example, the resin (12) can be among those, of polyurethane type, commonly used for operations of sealing and waterproofing structures, soils and rocks affected by percolation and infiltrations of water, even intense,

The sealing strip (11) is in turn, as mentioned above, generally made of a plastic material, such as for example, preferably but not exclusively, PVC (PolyVinylChloride) and has indicatively the technical features specified by the following table.

| Feature | Test Method | Value |
|---|---|---|
| Density (kg/dm3) | ISO 1183/87 | 1.19 |
| Shore hardness A (SH. A) | ISO 868/85 | 71 |
| Breaking load (kg/cm2) | ISO R 527/66 | 200 |
| Elongation (%) | ISO R 527/66 | 320 |

It is therefore clear, from the description given, that the present invention fully achieves its objects, and in particular proposes a new process and a corresponding system for the sealing of joints between ashlars, in particular in the construction and maintenance of walls and internal lining of tunnels and galleries, which offer performances, both as regards the ease and the times of execution, which are distinctly better and advantageous with respect to the current processes and systems of sealing.

Variants

Naturally, without prejudice to the principle and basic technical concepts of the present invention, it is also clear that the sealing process, the corresponding sealing system, and the special sealing strip used in this process and system may be subject to variations, modifications and improvements with respect to what has been described and illustrated hitherto, without thereby departing from the scope of the invention itself.

More particularly, the profile in section of the sealing strip (11) may take on different configurations and embodiments, all falling within the inventive concept of the invention, having in common the feature of being apt to co-operate, once the sealing strip (11) has been inserted in the joint (G) to be sealed, with the walls of the latter, so as to prevent both the escape of the sealing resin (12) that fills the interior of the joint (G) and the detachment of the sealing strip (11) from the same joint (G) due to the pressure P applied by the sealing resin (12) that is injected inside the joint (G).

Moreover, in the areas of joining between various joints defined by the ashlars, alternatively or in association with the use of the sealing strip (11), sealing can be advantageously carried out using appropriate profiles of joining which are inserted in the joints present in these joining areas.

Again, according to a further variant and as already underlined, the sealing resin (12) can be injected inside the joint (G), by means of the injector tool (A), in various ways and therefore not only from a single point or zone, in particular adjacent to one end of the sealing strip (11) once inserted in the joint (G) to be sealed, but from several points or zones, so as to distribute, starting from these points or zones, the sealing resin (12) along the extension of the joint (G) so as to fill it.

What is claimed is:

1. Process (10) for the sealing of joints (G) between prefabricated ashlars (C) or similar construction elements, comprising the following steps:
inserting of a sealing strip (11), of plastic material, in a joint (G), to be sealed, defined by two adjacent prefabricated ashlars (C);
injecting, by means of an injector tool (A), of a sealing resin (12) in the interior of the joint (G) to be sealed, so as to distribute, thanks to the containment and confinement action of the sealing strip (11) inserted in the joint (G), the sealing resin (12) along the extension of the joint (G) and therefore fill it;
wherein said sealing strip (11) has in section a configuration or profile apt to co-operate, once the sealing strip (11) has been inserted in the joint (G) to be sealed, with the walls of the same joint (G), so as to prevent both the escape of the sealing resin (12) that fills the interior of the joint (G) and the detachment of the sealing strip (11) from the joint (G) due to the pressure (P) applied by the sealing resin (12) that is injected inside the joint (G).

2. Process (10) according to claim 1, wherein said configuration or profile in section of said sealing strip (11) exhibits a plurality of inclined fins (11c) that protrude from a central body (11b) of the same sealing strip (11),
wherein said inclined fins (11c) are apt to co-operate with the walls of the joint (G) in which the sealing strip (11) is inserted so as to prevent both the escape of the sealing resin (12) that fills the interior of the joint (G) and the detachment of the sealing strip (11) from the same joint (G) due to the pressure (P) applied by the sealing resin (12) which is injected inside the joint (G).

3. Process (10) according to claim 2, wherein said sealing strip (11) has further in section:
a main body (11a), more particularly hollow, which is formed on one side of the configuration in section of the sealing strip (11) and from which said central body (11b) extends;
wherein said main body (11a) is configured to extend in length along the edge of the joint (G) that faces outwards, and said central body (11b) is configured to extend from said main body (11a) towards the interior of the joint (G), when the sealing strip (11) is inserted in the joint (G) to be sealed, and
wherein said main body (11a), said central body (11b), and said fins (11c), protruding from the central body (11b), of the sealing strip (11) are made in a single piece with said plastic material.

4. Process (10) according to claim 1, wherein the sealing resin (12) is injected inside the joint (G), by means of said injector tool (A), from one or more points or zones, so as to distribute, starting from said one or more points or zones, the sealing resin (12) along the extension of the joint (G) and therefore fill it.

5. Process (10) according to claim 4, wherein, after having inserted the sealing strip (11) in the joint (G) to be sealed, the sealing resin (12) is injected inside the joint (G) at a point or zone (Z) adjacent to one end (11)′) of the sealing strip (11), so as to distribute, starting from said point or zone, the sealing resin (12) along the extension of the joint (G) and therefore fill it.

6. Process (10) according to claim 1, wherein the plastic material constituting said sealing strip (11) is PVC.

7. System (20) for the sealing of joints (G), (G)′, (G)″) between prefabricated ashlars (C) or similar construction elements, comprising:
a sealing strip (11) of plastic material, and
a sealing resin (12),
wherein said sealing strip (11) is apt to be inserted in a joint (G) between two adjacent prefabricated ashlars (C) so as to extend, once inserted, along the joint (G) to be sealed;
wherein, after said sealing strip (11) has been inserted in the joint (G) to be sealed, said sealing resin (12) is provided to be injected, by means of an appropriate injector tool (A), in the interior of the joint (G), in particular in a point or zone (Z) adjacent to one end (11)′) of the sealing strip (11), so that the sealing resin (12) is distributed, thanks to the containment and confinement action of the sealing strip (11) inserted in the same joint (G), along the extension of the latter so as to fill it; and
wherein said sealing strip (11) has in section a configuration or profile exhibiting a plurality of inclined fins (11c), protruding from a central body (11b) of the same sealing strip (11), apt to co-operate with the walls of the joint (G), so as to prevent both the escape of the sealing resin (12) injected inside the joint (G) and the detachment of the sealing strip (11) from the joint (G) due to the pressure (P) applied by the sealing resin (12) when it is injected inside the joint (G).

8. System according to claim 7, wherein said sealing strip (11) has further in section:
a main body (11a), more particularly hollow, which is formed on one side of the configuration in section of the sealing strip (11) and from which said central body (11b) extends;
wherein said main body (11a), said central body (11b), and said fins (11c), protruding from the central body (11b), of the sealing strip (11) are made in a single piece.

9. Sealing strip (11), in plastic material, apt to seal a joint (G) between two prefabricated ashlars (C) or similar adjacent construction elements, characterised by a configuration or profile (11b) in section apt to co-operate, once the sealing strip (11) has been inserted in the joint (G) to be sealed, with the walls of the same joint (G), so as to prevent both the escape of the sealing resin (12) that fills the interior of the joint (G) and the detachment of the sealing strip (11) from the joint (G) due to the pressure (P) applied by the sealing resin (12) that is injected inside the joint (G).

10. Sealing strip (11) according to claim 9, wherein said configuration or profile in section comprises:
a main body (11a), more particularly hollow, formed on one side of the profile in section of the sealing strip (11);
a central body (11b), exhibiting an elongated shape, which extends from said main body (11a); and
a plurality of fins (11c), protruding from and formed along the two opposite sides of said central body (11b) of elongated shape,
wherein said main body (11a), said central body (11b) and said fins (111c), protruding from said central body (11b), are made in a single piece,
wherein said main body (11a) is configured to extend, when the sealing strip (11) is inserted in the joint (G) in order to seal it, along the edge of the same joint (G) that faces the exterior;
wherein said central body (11b) is configured to extend from said main body (11a) towards the interior of the joint (G), when the sealing strip (11) is inserted in the latter (G), and
wherein said fins (11c) have an inclination, with respect to said central body (1b) from which they protrude, such that, when said sealing strip (11) is subjected to a pressure (P) tending to detach it from the joint (G) in which the same sealing strip (11) is inserted, said fins (11a) co-operate in contact with the walls of the joint (G) so as to prevent the detachment of the sealing strip (11) from the joint (G).

11. Process (10) according to claim 2, wherein the sealing resin (12) is injected inside the joint (G), by means of said injector tool (A), from one or more points or zones, so as to distribute, starting from said one or more points or zones, the sealing resin (12) along the extension of the joint (G) and therefore fill it.

12. Process (10) according to claim 11, wherein, after having inserted the sealing strip (11) in the joint (G) to be sealed, the sealing resin (12) is injected inside the joint (G) at a point or zone (Z) adjacent to one end (11)′) of the sealing strip (11), so as to distribute, starting from said point or zone, the sealing resin (12) along the extension of the joint (G) and therefore fill it.

13. Process (10) according to claim 3, wherein the sealing resin (12) is injected inside the joint (G), by means of said injector tool (A), from one or more points or zones, so as to distribute, starting from said one or more points or zones, the sealing resin (12) along the extension of the joint (G) and therefore fill it.

14. Process (10) according to claim 13, wherein, after having inserted the sealing strip (11) in the joint (G) to be sealed, the sealing resin (12) is injected inside the joint (G) at a point or zone (Z) adjacent to one end (11)′) of the sealing strip (11), so as to distribute, starting from said point or zone, the sealing resin (12) along the extension of the joint (G) and therefore fill it.

15. Process (10) according to claim 2, wherein the plastic material constituting said sealing strip (11) is PVC.

16. Process (10) according to claim 3, wherein the plastic material constituting said sealing strip (11) is PVC.

17. Process (10) according to claim 4, wherein the plastic material constituting said sealing strip (11) is PVC.

18. Process (10) according to claim 5, wherein the plastic material constituting said sealing strip (11) is PVC.
